(19) United States
(12) Patent Application Publication
(10) Pub. No.: US 2017/0006255 A1
(43) Pub. Date: Jan. 5, 2017

(54) SYSTEM AND METHOD FOR EFFICIENT VIDEO-BASED MONITORING OF TRAFFIC VIOLATIONS

(71) Applicant: Safer Place Ltd., Tel Aviv (IL)

(72) Inventors: Uri KAREEV, Tel Aviv (IL); Ari SCHRIEBER, Ramat Gan (IL); Ori BERGER, New York, NY (US)

(73) Assignee: Safer Place Ltd., Tel Aviv (IL)

(21) Appl. No.: 15/265,881

(22) Filed: Sep. 15, 2016

Related U.S. Application Data
(63) Continuation of application No. PCT/US2015/027066, filed on Apr. 22, 2015.
(60) Provisional application No. 61/983,467, filed on Apr. 24, 2014.

(51) Int. Cl. H04N 7/01; G06K 9/00; G08G 1/017

(52) U.S. Cl. CPC H04N 7/013; G08G 1/0175; G06K 9/00785

(57) ABSTRACT

A system and method for efficient video-based traffic monitoring are provided. The method includes receiving a first video stream potentially capturing road behavior violations; converting the first video stream into a second video stream, the first video stream having a first data rate and the second video stream having a second data rate, wherein the second data rate is lower than the first data rate; transmitting the second video stream to a remote node; receiving a request from the remote node for at least one portion of the first video stream; and transmitting the at least one portion of the first video stream, wherein the at least one portion is transmitted at the first data rate.

### CROSS-REFERENCE TO RELATED APPLICATIONS

This application is a continuation of PCT application No. PCT/US2015/027066, filed on Apr. 22, 2015, which claims the benefit of U.S. Provisional Application No. 61/983,467 filed on Apr. 24, 2014, the contents of which are hereby incorporated by reference.

### TECHNICAL FIELD

The present disclosure relates generally to traffic monitoring systems, and more particularly to systems for monitoring potential traffic violations.

### BACKGROUND

Camera-based traffic monitoring systems are deployed by law enforcement inspectors to enforce parking and traffic laws in an attempt to detect unsafe road behavior from illegal parking (i.e., non-moving violations) to driving habits (i.e., moving violations). Although video has been used for identification and prosecution of vehicles in violation of traffic laws, the operation of transmitting high data-rate video streams over the network to be analyzed by a traffic officer consumes a large amount of bandwidth.

In addition, such video evidence frequently documents other civilians and private property that are irrelevant to the violation allegedly being performed. Such unrelated content does not need to be transmitted to traffic officers to verify that traffic violations have occurred. More particularly, transmission of video segments that only contain irrelevant content leads to wasteful bandwidth consumption due to unnecessary transmissions.

It would therefore be advantageous to provide a solution for efficient video-based monitoring of traffic violations.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for efficient video-based traffic monitoring. The method comprises receiving a first video stream potentially capturing road behavior violations; converting the first video stream into a second video stream, the first video stream having a first data rate and the second video stream having a second data rate, wherein the second data rate is lower than the first data rate; transmitting the second video stream to a remote node; receiving a request from the remote node for at least one portion of the first video stream; and transmitting the at least one portion of the first video stream, wherein the at least one portion is transmitted at the first data rate.

The disclosed embodiments also include a system for efficient video-based traffic monitoring. The system comprises a processing unit; and a memory, the memory containing instructions that, when executed by the processing unit, configure the system to: receive a first video stream potentially capturing road behavior violations; convert the first video stream into a second video stream, the first video stream having a first data rate and the second video stream having a second data rate, wherein the second data-rate is lower than the first data-rate; transmit the second video stream to a remote node; receive a request from the remote node for at least one portion of the first video stream; and transmit the at least one portion of the first video stream, wherein the at least one portion is transmitted at the first data-rate.

The disclosed embodiments also include a method for efficient video-based traffic monitoring. The method comprises transmitting a second video stream having a second data-rate, wherein the second video stream correlates to a first video stream having a first data-rate, wherein the second data-rate is lower than the first data-rate; receiving a request for at least one portion of the first video stream and at least one identifier; determining, based on the at least one identifier, whether a user is eligible to view the first video stream; and upon determining that the user is eligible to view the first video stream, transmitting the at least one portion of the first video stream.

The disclosed embodiments also include a system for efficient video-based traffic monitoring. The system comprises a processing unit; and a memory, the memory containing instructions that, when executed by the processing unit, configure the system to: transmit a second video stream having a second data-rate, wherein the second video stream correlates to a first video stream having a first data-rate, wherein the second data-rate is lower than the first data-rate; receive a request for at least one portion of the first video stream and at least one identifier; determine, based on the at least one identifier, whether a user is eligible to view the first video stream; and upon determining that the user is eligible to view the first video stream, transmit the at least one portion of the first video stream.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system utilized to describe the disclosed various embodiments for efficient video-based monitoring of traffic violations.

FIG. 2 is a flowchart illustrating a method for monitoring traffic violations according to an embodiment.

FIG. 3 is a flowchart illustrating a method for monitoring traffic violations according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for monitoring road behavior events, such as road violations, vehicle parking busses stopping and more. Multiple video streams from one or more cameras are received including at least a first video stream having a first quality, combining data-rate frame rate and compression parameters. The first video stream is converted to a second video stream having a second quality such as a lower data-rate or lower frame rate, such conversion can take place in a processing element in the camera or in another processing element connected to the camera. The second video stream is transmitted to a remote node. Upon receipt of a request from a user of the remote node for a portion of the first video stream, the selected portion of the first video stream is provided to the remote node. According to one embodiment, the portion of the first video stream is provided to the remote node based on one or more user-based thresholds. The video streams are also available for review in various levels of details in order to reduce network requirements, or to protect the privacy of the recorded content.

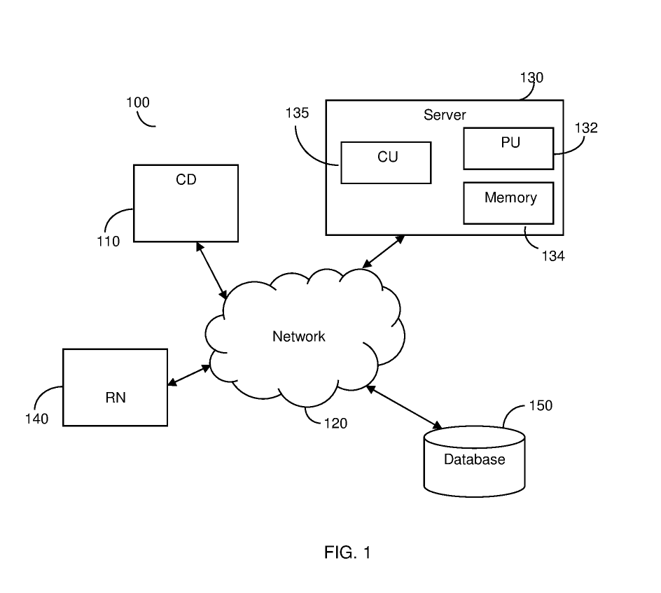

FIG. 1 shows an exemplary and non-limiting schematic block diagram of a system 100 utilized to describe the various disclosed embodiments for efficient video-based monitoring of traffic violations. The system 100 comprises at least one capturing device (CD) 110 configured to capture one or more video streams and may be, but is not limited to, a video camera, a webcam, a camcorder, a closed-circuit television, a surveillance camera, or such device coupled with local processing and storage and so on. It should be noted that a single capturing device 110 is shown merely for simplicity and without limitation on the various disclosed embodiments. Multiple capturing devices 110 may be used without departing from the scope of the disclosed embodiments.

The capturing device 110 is communicatively connected to a network 120. The network 120 may be, but is not limited to, a local area network (LAN), a wide area network (WAN), a metro area network (MAN), the world wide web (WWW), the Internet, a wired network, a wireless network, and the like, as well as any combinations thereof.

A server 130 including a conversion unit (CU) 135 is further communicatively connected to the network 120. The server 130 also includes a processing unit (PU) 132 and a memory 134. In an embodiment, the conversion unit 135 may be communicatively connected either to the capturing device 110 or to the server 130 as further described herein below, either directly or over the network 120.

In an embodiment, the conversion unit 135 is configured by the server 130 to convert a first video stream having a first data-rate to a second video stream having a second data-rate. According to an embodiment, the conversion unit 135 is further configured to graphically modify one or more portions of the first video stream. Graphically modifying may include, but is not limited to, brightening, darkening, or blurring of one or more portions of the first video stream or adding fixed or dynamic text to the video. Graphically modifying the first video stream enables hiding or emphasizing one or more elements shown in the first video stream for, e.g., privacy protection and/or making darkened portions of the video readily visible.

The processing unit 132 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

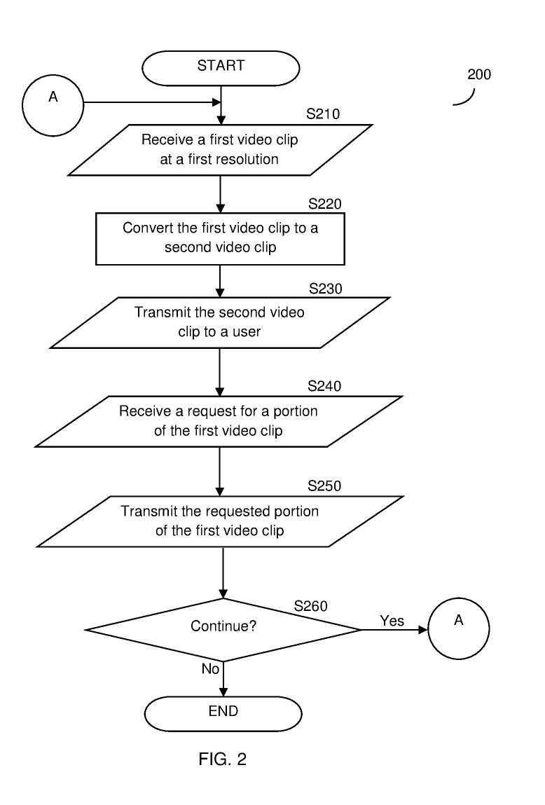

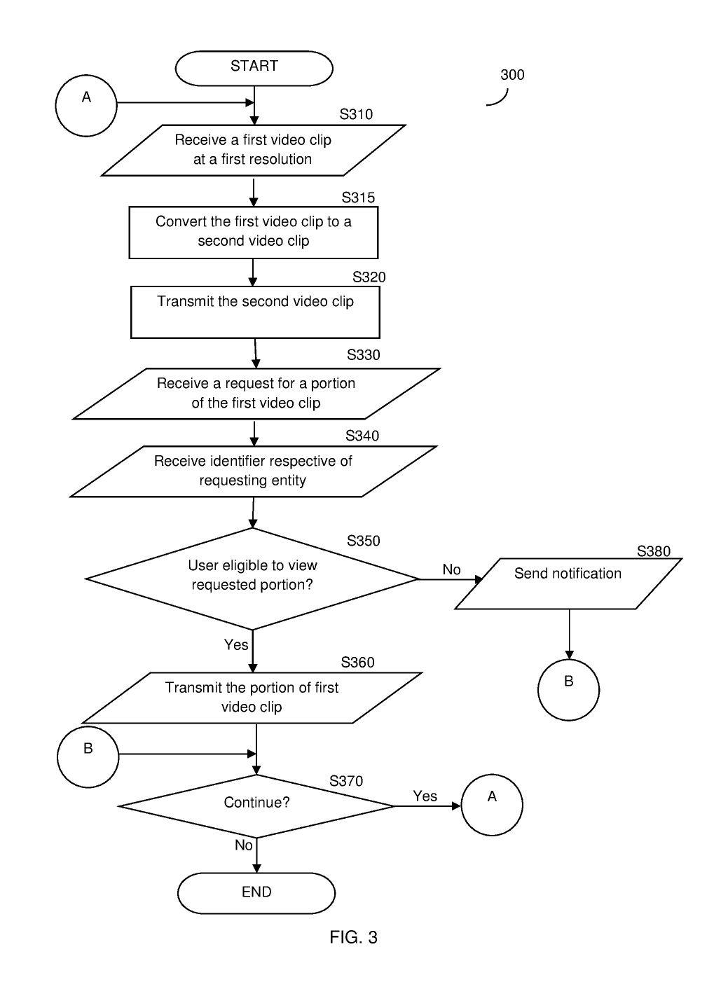

The processing unit 132 may be coupled to the memory 134. In an embodiment, the memory 134 contains instructions that, when executed by the processing unit 132, results in the performance of the methods described herein below with respect to FIGS. 2 and 3. Specifically, the processing unit 132 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 132 to perform the various functions described herein.

The system 100 further includes a remote node (RN) 140 that is communicatively connected to the network 120. The remote node 140 may be, but is not limited to, a smart phone, a mobile phone, a laptop, a tablet computer, a desktop computer, a server computer, a portable device and other kinds of wired and wireless appliances. The system 100 further comprises a database (DB) 150 configured to store video streams and/or portions thereof for further uses. The database 150 is also communicatively connected to the network 120.

According to an embodiment, the server 130 receives a first video stream having a first data-rate from the capturing device 110. The server 130 initializes the conversion unit 135 to convert the first video stream to a second video stream having a second data-rate. In an embodiment, the second resolution of the video stream is a lower resolution from the first data-rate. In another exemplary embodiment, instead of or in addition to being a lower video data-rate that the first video stream, the second video stream is shorter and/or has a slower frame rate than the first video stream. By initially sending a second video stream that consumes less bandwidth to transmit than a first video stream and receiving a selection of a portion of the first video stream, the bandwidth consumption from sending the portion of the first video stream is minimized.

The second video stream correlates to the first video stream. Two video streams are correlating if, e.g., the video streams show the same footage, even if the video streams have different data-rates, or different frame rates. In an embodiment, the conversion includes graphically modifying the first video stream. Graphically modifying may include, but is not limited to, brightening, darkening, or blurring of one or more portions of the first video stream. Graphically modifying the first video stream enables hiding or emphasizing one or more elements shown in the first video stream for, e.g., privacy protection and/or making darkened portions of the video readily visible.

According to another embodiment, the server 130 is configured to receive both the first video stream and the second video stream from the capturing device 110. The server 130 is then configured to transmit the second video stream to the remote node 140 over the network 120.

A request for at least one portion of the first video stream is received from the remote node 140. In an embodiment, the request may further contain a selection of a portion of the second video stream. In an exemplary embodiment, the selection may be received based on a user gesture over the remote node 140. A user gesture is an activity (or inactivity) performed by a user that is predetermined to indicate a selection and may be, but is not limited to, a tap, a click, a swipe, a press, a drag, hovering a mouse icon over an area for a predetermined amount of time, and so on.

Alternatively or collectively, the portion of the second video stream is automatically selected by the server 130 or the remote node 140. The selection may include processing the first video stream, for example, using known image processing techniques, to detect a set of predefined events or conditions. Such events include, for example, identification of a red light and a vehicle crossing the intersection, a vehicle parking next to a fire hydrant, and so on.

Responsive to the selection received from the remote node 140 or the server 130, at least one portion of the first video stream corresponding to the selected at least one portion of the second video stream is provided to the remote node 140 by the server 130. It should be noted that the portion of the first video stream is provided at the same data-rate and/or resolution and/or framerate as that of the first video stream. The portion of the first video stream allows a user to identify details in the video stream such as, e.g., precise positions of vehicles, license plate numbers, vehicle make and model, violation duration and so on. Portions of streams may correspond when, for example, both portions begin and/or end at the same time in the video. As a non-limiting example, if a user of the remote node 140 selects a portion of the second video that occurs between 2 minutes into the video and 3 minutes into the video stream, the corresponding portion of the first video stream will also feature content from between 2 minutes into the video stream and 3 minutes into the video stream. By first providing a lower data-rate video stream, the disclosed embodiments decrease bandwidth consumption that would be caused by transmitting of high data-rate video streams over the network 120.

As a non-limiting example, two video streams featuring an intersection are captured by the capturing device 110, wherein a first video stream is at a resolution of 720p (i.e., high definition) and a second video stream is at a data-rate of 240 (i.e., low definition). The first video stream requires 60 megabytes to transmit, while the second video requires 10 megabytes to transmit. The server 130 is configured to generate and transmit the lower data-rate second video stream to a traffic officer operating the remote node 140. The server 130 is further configured to transmit a selection of a portion of the second video stream based on a user gesture from the traffic officer via the remote node 140 indicating that a potential traffic violation has been identified. In this example, the selected portion of the second video stream is between 1 minute and 2 minutes into the video and shows a car moving through an intersection during a red traffic light.

Responsive to the selection, the server 130 provides the corresponding portion of the high data-rate first video stream (i.e., the portion between 1 minute and 2 minutes into the first video stream) to the remote node 140 to enable the traffic officer to better identify the violation and the violator. The portion of the first video stream requires 5 megabytes to transmit. In this example, the traffic officer determines that the car had not stopped at the intersection and that the light was already red when the car proceeded into the intersection. Thus, the traffic officer determines that the moving violation of running a red light has been performed by the person owning the car with the identified license plate number. The total amount of data consumed by the transmission of the second video stream (10 megabytes) and the portion of the first video stream (5 megabytes) is 5 megabytes, which is significantly less than the 60 megabytes required to transmit the entire first video.

As another non-limiting example, a first video stream featuring an intersection is captured by the capturing device 110 at a framerate of 30 frames per second (fps) that requires 50 megabytes to transmit. The server 130 initializes the CU 135 to convert the first video stream into a second video stream at a framerate of 15 fps that requires 25 megabytes to transmit. The server 130 provides the second video stream to a traffic officer operating the remote node 140. The server receives a selection of a portion of the lower data-rate second video stream based on a user gesture from the traffic officer via the remote node 140 indicating that a potential parking violation has been identified. In this example, the selected portion of the second video stream is between 5 minutes and 6 minutes into the video and shows a car parked in a handicap spot.

Responsive to the selection, the server 130 provides the corresponding portion of the first video stream (i.e., the portion between 5 minutes and 6 minutes into the video) to the RN 140 to enable the traffic officer to better identify the violation and the violator. The portion of the first video stream requires 10 megabytes to transfer. In this example, the traffic officer determines that the car parked in the handicap spot does not possess handicap plates or tags, and identifies the license plate number of the car. Thus, the traffic officer may determine that a parking violation of illegally parking in a handicap spot has been performed by the person owning the car with the identified license plate number. The total amount of data consumed by the transmission of the second video stream (25 megabytes) and the portion of the first video stream (10 megabytes) is 35 megabytes, which is significantly less than the 50 megabytes required to transmit the entire first video.

FIG. 2 depicts an exemplary and non-limiting flowchart 200 describing a method for efficient video-based traffic violation monitoring according to an embodiment. In various embodiments, the steps of flowchart 200 may be performed by a server (e.g., the server 130). In S210, a first video stream is received from a capturing device 110.

In optional S220, the first video stream is converted to a second video stream. In an embodiment, the conversion may be performed by a conversion unit (e.g., the CU 135). The data size of the second video stream is lower than the first video stream in cases where the data-rate of the second video stream is lower than a data-rate of the first video stream or achieved by frame rate reduction, a combination of them or other techniques discussed in the related art. In an embodiment, the conversion further includes graphically modifying of the first video stream. Graphically modifying may be, but is not limited to, brightening, darkening, or blurring of one or more portions of the at least one video stream. Graphically modifying the first video stream enables hiding or emphasizing one or more elements shown in the video stream for, e.g., privacy protection and/or making darkened portions of the video readily visible. In another embodiment, the second video is converted to a length that is shorter and/or a frame rate that is lower than that of the first video stream.

The second video stream correlates to the first video stream. Two video streams are correlating if, e.g., the video streams have the same footage, even if the video streams have different data-rates, frame rates or other visual changes that do not materially alter the essence of the scene viewed, and so on.

In S230, the second video stream is transmitted to a remote node of a user. The user may be a user such as a traffic officer, or a machine such as processor running video analytics application(s). In S240, a request for at least one portion of the first video stream is received. In an embodiment, the request may be based on a selection by the user of at least one portion of the second video stream. A portion of a video stream may be selected based on a user gesture. Such selected first video portion may be of varying length ranging from a single frame to full video segments, may be cropped or may be recompressed or altered as described above.

In certain exemplary embodiments, a user gesture is an activity (or inactivity) performed by a user that is predetermined to indicate a selection and may be, but is not limited to, a tap, a click, a swipe, a press, a drag, hovering a mouse icon over an area for a predetermined amount of time, and so on, or a digital marking of the request. The requested at least one portion of the first video stream corresponds to the selected at least one portion of the second video stream. Portions of streams may correspond if, e.g., each corresponding portion begins and/or ends at the same time in the video. As a non-limiting example, portions of streams may correspond if they both begin at 3 minutes 45 seconds into the video and end at 4 minutes into the video.

In an optional embodiment, the at least one portion is automatically selected. Such selection may occur upon receiving a set of predefined events from the user. Predefined events that may be useful in determining road behavior violations include, but are not limited to, detecting movement through an intersection during a red light, continual movement through a stop sign, parking near a fire hydrant, parking in a handicap spot, stopping the vehicle in excess of a predefined time, and so on.

In S250, the at least one requested portion of the first video stream is transmitted to the user. In an embodiment, the at least one requested portion may be transmitted to a remote node (e.g., the RN 140). In S260, it is checked whether additional video streams have been received and, if so, execution continues with S210; otherwise, execution terminates.

As a non-limiting example, a first video stream at a first data-rate of 1080p featuring an intersection is received. The first video stream requires 100 megabytes to transmit. The first video stream is converted into a second video stream of a lower data-rate of 360p that requires 35 megabytes to transmit. The second video stream is transmitted to a traffic officer operating a smart phone. Two user gestures representing selections of two portions of the second video stream are received. In this example, the selected portions of the second video stream are between 1 minute and 2 minutes into the video and between 5 minutes and 5 minutes 30 seconds into the video and require 20 megabytes and 10 megabytes to transmit, respectively.

In this example, the selected positions indicate vehicles crossing the intersection at a red traffic light. Responsive to the selection, the corresponding portions of the first video stream (i.e., the portions between 1 minute and 2 minutes into the video and between 5 minutes and 5 minutes 30 seconds into the video) are transmitted to the traffic officer to enable the traffic officer to better identify the violation and the violator. It should be noted that the selection portions are transmitted at a higher quality, e.g. data-rate, frame rate or compression parameters than the second video stream. This would allow the traffic officer to identify, for example, the details of the license plates of the violating vehicles, as such details cannot be readily identified in a lower quality video. The total data required to transmit the second video stream (35 megabytes) and the portions of the first video stream (20 megabytes and 10 megabytes, respectively) is 65 megabytes, which is significantly lower than the 100 megabytes required to transmit the entire first video stream.

FIG. 3 depicts an exemplary and non-limiting flowchart 300 illustrating a method for efficient video-based traffic violation monitoring based on identifiers according to an embodiment. In S310, a first video stream at a first quality is received. In an optional embodiment, a second video stream at a second quality such as a different data-rate may be received. The second data-rate is lower than the first data-rate.

In optional S315, the first video stream is converted to a second video stream. The second video stream correlates to the first video stream. Two video streams are correlating if, e.g., the video streams show essentially the same scene, even if the video streams have different video parameters such as data-rate, frame rate, and so on. According to one embodiment, the conversion includes graphically modifying the first video stream. Graphically modifying may include, but are not limited to, brightening, darkening, or blurring of one or more portions of the first video stream. Graphically modifying the first video stream enables hiding or emphasizing one or more elements shown in the video stream for, e.g., privacy protection and/or making darkened portions of the video readily visible. In an embodiment (not shown), the video stream is sent to a remote node (e.g., the RN 140) and the remote node determines one or more portions to be graphically modified. In S320, the second video stream is sent to a user.

In S330, a request for at least one portion of the first video stream is received. In an embodiment, the request may be based on a selection by the user of at least one portion of the second video stream. A portion of a video stream may be selected based on a user gesture. The requested at least one portion of the first video stream corresponds to the selected at least one portion of the second video stream. Portions of streams may correspond if, e.g., each corresponding portion begins and/or ends at the same time in the video.

In S340, one or more identifiers related to a remote node (e.g., the RN 140) or the user thereof are received. The identifiers provide information related to the user and/or the remote node that may include, but is not limited to, a user identity, a user's job, a security clearance of the user, a security status of the remote node, and so on.

In S350, it is determined whether the user is eligible to view the requested at least one portion based on the received user identifiers and, if so, execution continues with S360; otherwise, execution continues with S380. In S360, the at least one portion of the first video stream is transmitted. In S370, it is checked whether additional video streams have been received and, if so, execution continues with S310; otherwise, execution terminates.

In S380, a notification indicating that the user does not have permission to view the higher data-rate video stream is sent to the user and execution continues with S370.

As a non-limiting example, three first video streams from three cameras installed in a car in which a first vehicle and a second vehicle are shown are received. Each of the three first video streams is converted into a respective second video stream. In this example, conversion includes creating lower data-rate versions of the three first video streams and blurring portions of the lower data-rate versions. A selection of at least one portion of the respective second video streams is received.

Responsive to the selection, identifiers respective of the requesting entity are received. In this example, the identifiers include whether the user is a civilian or an officer of the court. According to this example, civilian users may only receive the blurred second video stream versions of the video, while officers of the court may receive the higher data-rate three first video streams. Based on the identifiers, it is determined that the user is a civilian. Thus, the at least one portion of the respective second video streams is transmitted to the user.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for efficient video-based traffic monitoring, comprising:
receiving a first video stream potentially capturing road behavior violations;
converting the first video stream into a second video stream, the first video stream having a first data rate and the second video clip having a second data rate, wherein the second data rate is lower than the first data rate;
transmitting the second video stream to a remote node;
receiving a request from the remote node for at least one portion of the first video stream; and
transmitting the at least one portion of the first video stream, wherein the at least one portion is transmitted at the first data-rate.

2. The method of claim 1, wherein the conversion of the first video stream into the second video stream further comprises:
reducing a frame rate of the first video stream.

3. The method of claim 1, wherein the second video stream correlates to the first video stream.

4. The method of claim 1, wherein converting the first video stream into the second video stream further comprises:
graphically modifying the first video stream.

5. The method of claim 1, wherein converting the first video stream into the second video stream further comprises:
reducing a frame rate of the first video stream.

6. The method of claim 1, wherein the request for the at least one portion includes a selection of at least one portion of the second video stream corresponding to the at least one portion of the first video stream.

7. The method of claim 1, further comprising:
identifying the at least one portion of the first video stream based on a predefined event.

8. The method of claim 1, further comprising:
determining, based on the at least one identifier, whether the user is eligible to view the first video clip; and
upon determining that the user is eligible to view the first video clip, transmitting the at least one portion of the first video clip.

9. A non-transitory computer readable medium having stored thereon instructions for causing one or more processing units to execute the method according to claim 1.

10. A system for efficient video-based traffic monitoring, comprising:
a processing unit; and
a memory, the memory containing instructions that, when executed by the processing unit, configure the system to:
receive a first video stream potentially capturing road behavior violations;
convert the first video stream into a second video stream, the first video stream having a first data-rate and the second video stream having a second data-rate, wherein the second data-rate is lower than the first data-rate;
transmit the second video stream to a remote node;
receive a request from the remote node for at least one portion of the first video stream; and
transmit the at least one portion of the first video stream, wherein the at least one portion is transmitted at the first data-rate.

11. The system of claim 10, wherein the system is further configured to:
graphically modify the first video stream.

12. The system of claim 10, wherein the system is further configured to:
receive a selection of at least a portion of the second video stream corresponding to the at least a portion of the first video stream.

13. The system of claim 11, wherein the selection is based on at least one of: a user gesture and a digital processing decision.

14. A method for efficient video-based traffic monitoring, comprising:
transmitting a second video stream having a second data-rate, wherein the second video stream correlates to a first video stream having a first data-rate, wherein the second data-rate is lower than the first data-rate;
receiving a request for at least one portion of the first video stream and at least one identifier;
determining, based on the at least one identifier, whether a user is eligible to view the first video stream; and
upon determining that the user is eligible to view the first video stream, transmitting the at least one portion of the first video stream.

15. The method of claim 14, further comprising:
converting the first video stream into the second video stream.

16. The method of claim 15, wherein converting the first video stream into the second video stream further comprises:
graphically modifying the first video stream.

17. The method of claim 15, wherein the conversion of the first video stream into the second video stream further comprises:
reducing the data rate of the first video stream.

18. The method of claim 15, wherein receiving a request for at least a portion of the first video stream and at least one identifier further comprises:
receiving a selection of at least a portion of the second video stream corresponding to the at least a portion of the first video stream.

19. The method of claim 18, wherein the selection is based on at least one of: a user gesture and a digital processing decision.

20. A non-transitory computer readable medium having stored thereon instructions for causing one or more processing units to execute the method according to claim 13.

21. A system for efficient video-based traffic monitoring, comprising:
a processing unit; and
a memory, the memory containing instructions that, when executed by the processing unit, configure the system to:
transmit a second video stream having a second data-rate, wherein the second video stream correlates to a first video stream having a first data-rate, wherein the second data-rate is lower than the first data-rate;
receive a request for at least one portion of the first video stream and at least one identifier;
determine, based on the at least one identifier, whether a user is eligible to view the first video stream; and
upon determining that the user is eligible to view the first video stream, transmit the at least one portion of the first video stream.

22. The system of claim 21, wherein the system is further configured to:
convert the first video stream into the second video stream.

23. The system of claim 22, wherein the system is further configured to:
graphically modify the first video stream.

24. The system of claim 22, wherein the system is further configured to:
reduce the data rate of the first video stream.

25. The system of claim 21, wherein the system is further configured to:
receive a selection of at least a portion of the second video stream corresponding to the at least a portion of the first video stream.

26. The system of claim 25, wherein the selection is based on at least one of: a user gesture and a digital processing decision.
